(19) United States
(12) Patent Application Publication
(10) Pub. No.: US 2013/0013463 A1
(43) Pub. Date: Jan. 10, 2013

(54) Process for barter of virtual goods

(75) Inventor: Darren McKeeman, San Francisco, CA (US)

(73) Assignees: Mad River Entertainment; Jim Fox, San Francisco, CA (US)

(21) Appl. No.: 13/177,861

(22) Filed: Jul. 7, 2011

(51) Int. Cl. G06Q 30/00

(52) U.S. Cl. 705/27.2

(57) ABSTRACT

Means of trading of virtual goods

### DETAILED DESCRIPTION SPECIFIC

The Internet comprises a vast number of computers and computer networks that are interconnected through communication links. The interconnected computers exchange information using various services, such as electronic mail, Gopher, and the World Wide Web (“WWW”). The WWW service allows a server computer system (i.e., Web server or Web site) to send graphical Web pages of information to a remote client computer system. The remote client computer system can then display the Web pages. Each resource (e.g., computer or Web page) of the WWW is uniquely identifiable by a Uniform Resource Locator (“URL”). To view a specific Web page, a client computer system specifies the URL for that Web page in a request (e.g., a HyperText Transfer Protocol (“HTTP”) request). The request is forwarded to the Web server that supports that Web page. When that Web server receives the request, it sends that Web page to the client computer system. When the client computer system receives that Web page, it typically displays the Web page using a browser. A browser is a special-purpose application program that effects the requesting of Web pages and the displaying of Web pages.

Currently. Web pages are typically defined using HyperText Markup Language (“HTML”). HTML provides a standard set of tags that define how a Web page is to be displayed. When a user indicates to the browser to display a Web page, the browser sends a request to the server computer system to transfer to the client computer system an HTML document that defines the Web page. When the requested HTML document is received by the client computer system, the browser displays the Web page as defined by the HTML document. The HTML document contains various tags that control the displaying of text, graphics, controls, and other features. The HTML document may contain URLs of other Web pages available on that server computer system or other server computer systems.

The World Wide Web is established as an e-commerce hub, and many of the purchases made on the World Wide Web are virtual in nature, meaning that they consist of products that are just files on a computer. These purchases include virtual currency, music, magazines, comic books, and video. These goods are referred to as virtual goods. The content is the value in virtual goods, and to guarantee that they are paid for the content, the rights holders will often protect the file with Digital Rights Management (“DRM”), which is a system for controlling or restricting or limiting the ability of the user or consumer of virtual goods (or of files containing content of value) to view, use, access, copy, transfer, distribute or redistribute said virtual goods or files. Rights holders are concerned that without DRM in place, uncontrolled copying and distribution will undermine the value of the virtual goods.

So users are prevented or discouraged from trading or exchanging tiles of valuable content. This eliminates a time-honored aspect from the world of real goods—the ability to trade.

In the world of real goods, people can trade LPs (or CDs), comic books, toys and toy accessories, paperback books, etc. Networks of friends and clubs have been built based on a desire to trade items of common interest.

With DRM controls, the trading that has long been a tradition with real goods is severely curtailed in the world of virtual goods. However this can have an adverse impact on demand for the virtual goods. When groups of fans can get together to trade and barter items of common interest (comic books or a genre of music, as examples), this can create prolonged and increased demand for the goods, which enhances their value.

Therefore, there is a need for a means to trade virtual goods in a manner analogous to trade of real goods. In a preferred embodiment, a means for trading virtual goods would allow consumers of the virtual goods to haggle and barter and trade items. It would also control rights to view, use or access the virtual goods. and would limit, restrict or prevent copying of the virtual goods, thereby maintaining the value of the virtual goods. In another embodiment, transaction fees would be imposed on the trade of virtual goods, with the fees being paid in real currency and/or virtual currency and/or a combination of the two. In another embodiment, transaction fees from trades accrue to the party that manages the virtual trading. In another embodiment, transaction fees from trades accrue to the party (or parties) that holds rights in the items being traded. In another embodiment, transaction fees are divided between the party that manages the virtual trading and the party (or parties) that holds rights in the items being traded.

### DESCRIPTION OF SYSTEM AND PROCESS FOR TRADING VIRTUAL GOODS

The process of trading virtual goods (virtual trading) is dependent upon several supporting systems. A server computer system to identify and authorize all users is first required. There are many that exist on the Internet today, including those provided by Facebook.com, Myspace.com, and Twitter.com. It also is dependent upon a server computer system set up to act as a holding space for the electronic files that comprise the virtual goods. In today's terms this is called a “cloud”. Rights holders (usually the creators or publishers of the virtual goods) can upload their files to the cloud.

In one embodiment, the files never leave the cloud; users (the consumers of the virtual goods) can only access the virtual goods via the cloud. If the virtual goods only exist on the cloud—i.e. only on servers and not on the users' personal devices—it is possible to maintain absolute control over access to the files.

Virtual trading also requires a system or method for allowing users to barter, haggle and ultimately agree to a trade of virtual goods. Finally, virtual trading also requires a system or method to keep control access to virtual goods—i.e. to keep track of which users are authorized to view, use or access the virtual goods.

In another embodiment of virtual trading, the virtual goods may be downloaded to and may reside on users' personal devices (PCs, tablet computers, smart phones and similar devices). In this embodiment, when a user concludes a trade the files that contain the virtual goods that he traded away are deleted from his local device and files that contain the virtual goods that he received in the trade are downloaded to his personal device. In a preferred embodiment. the files containing virtual goods are encrypted and/or are invisible files and/or have DRM restrictions placed on them.

An advantage of storing the virtual goods on the user's personal device is that the user does not need to be connected to the cloud to view, use or access the virtual goods. A disadvantage of storing the virtual goods on the user's personal device is that the user might be able to find the files and then decrypt them or overcome the DRM restrictions, and then could copy and distribute the virtual goods in an uncontrolled manner.

The embodiment of the present invention provides a method for a client system to trade a file with another client system. The client system is provided with an identifier that identifies a customer. The client system displays information that identifies the item and displays and action to select that item and propose a trade. In response to the indicated action being performed, the client system sends to a server system the provided identifier and a file upload form to upload a file to trade for the identified item. The server system accepts the identifier of the user and the uploaded file and informs the client system of the owner of the identified item of the pending trade. The uploaded file is accepted for trade, and the server computer system releases both files for download to their respective client systems.

The server system receives and stores the information for users using various computer systems so that the server system can store the virtual items that are uploaded. The server system stores the received information in association with an identifier of the user and provides the identifier to the client system. When requested by the client system, the server system provides information describing the item to the requesting client system. When the server system receives a request from a client system. the server system combines the information stored in association with the identifier included in the request to effect the trading of the item.

In layman's terms, two means of trading or bartering virtual goods are disclosed.

First Means—with the Virtual Goods Stored Locally on the Users' Devices.

User A has one or more virtual goods stored on his personal device (tablet, cell phone, PC, etc.). Similarly, User B has one or more virtual goods stored on his personal device. Access to the virtual goods for both users is controlled and verified by a DRM system that can selectively and remotely enable and disable the ability of the Users to view, use, or otherwise access the virtual goods. The ability to do this is called “control of virtual ownership”, or just “ownership control”.

User A and User B each decide'to make one or more of their virtual goods available for trade. They find out about each other's goods available for trade, preferably through an online trading system that is provided by the same party that exercises control of virtual ownership of the virtual goods. User A and User B reach mutual agreement to trade one or more of each of their virtual goods for one or more of the virtual goods owned by the other party. The trade is then executed by exchanging the virtual goods. I.e. the virtual goods that User A is trading are uploaded off of his local device and/or erased from his local device, and the virtual goods he is receiving from User B are loaded onto his local device. An analogous change of files occurs on the local device of User B. Preferably, the entity that control virtual ownership of the virtual goods causes these actions to occur, and modifies the DRM rights of all of the files to reflect the new ownership of the virtual goods.

In a preferred embodiment, the files containing virtual goods that are downloaded to the users' personal devices are hidden/invisible files and/or are encrypted and/or have DRM controls. These characteristics of the files put constraints on the ability of users to copy and/or redistribute the files.

### Second Means—Virtual Goods Stored on the Cloud

From the perspective of Users A and B, the transaction is almost identical as in the first means. The difference is that the virtual goods reside on servers in the cloud, not on the local devices of the Users. Virtual ownership of the goods is managed by a DRM system that controls the ability of users to view, use or access virtual goods that are stored on servers in the cloud.

After Users A and B agree to a trade, consummation of the trade is effected by modifying the access permissions each user has for the virtual goods that are involved in the trade. User A no longer has access to the virtual goods that he traded away, and now has access to the virtual goods that he received in the trade. An analogous change in access rights is made for User B. In this case, it is not necessary to upload and download files, or to erase files from storage on any local devices.

In a preferred embodiment, a managing party (usually the party that manages the DRM system and/or controls virtual ownership of or access to the virtual goods) will charge a commission for the trade. One or both of the Users involved in the trade will pay the commission, and payment can be in real money or in virtual currency or a combination of the two.

In another preferred embodiment, access to the DRM and user authorization systems is controlled by passwords, firewalls or other well known security means to prevent unauthorized access to these systems.

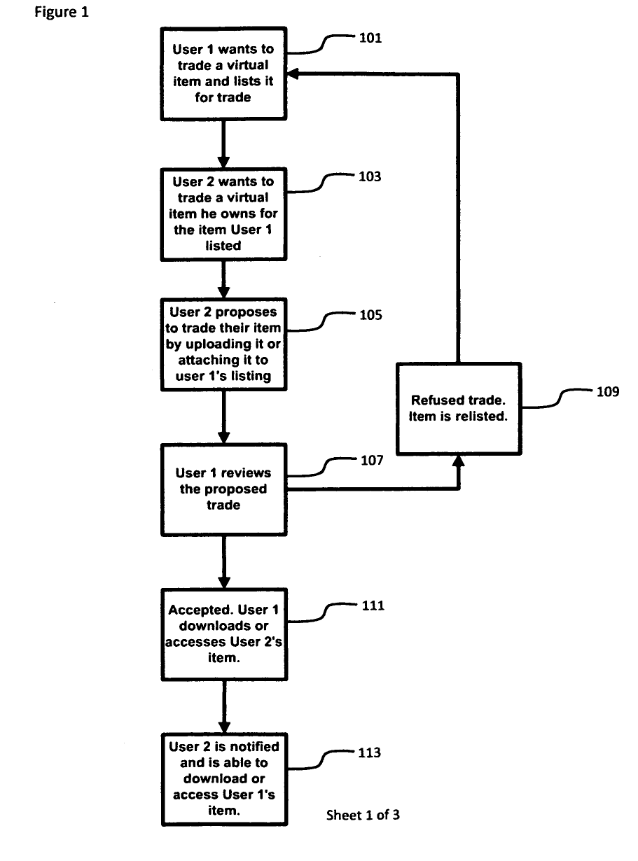

FIG. 1 shows a flowchart of the steps a user goes through to trade a file with another user when files are stored on the users' personal devices.

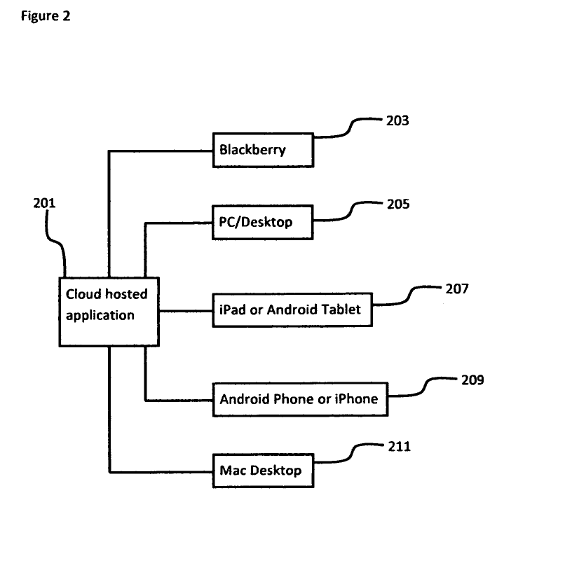

FIG. 2 shows a diagram of a cloud-based system for trading virtual goods and examples of devices that can connect attach to said cloud-based system.

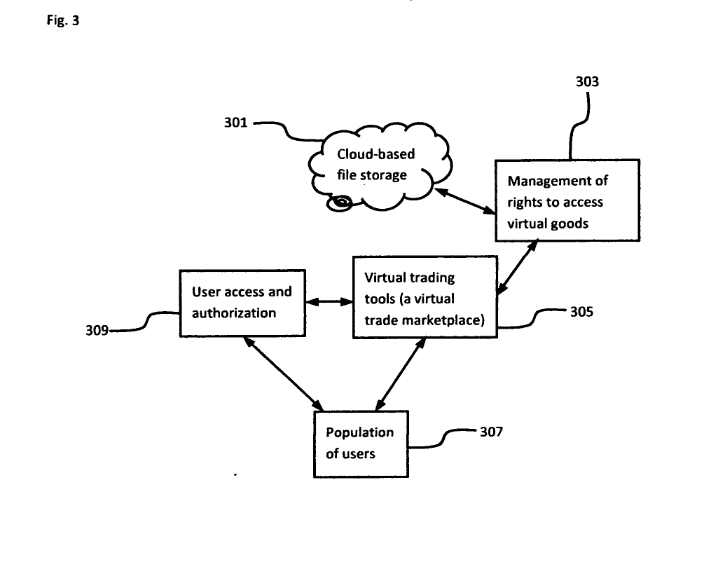

FIG. 3 shows a diagram of a system for trading in which virtual goods reside in the cloud and are not downloaded to users' personal devices.

1. A method of trading virtual goods on a display, comprising:
a. providing a memory which is able to store a series of virtual goods at an adjacent series of addresses in said memory,
b. providing a means which a human operator can use to manipulate a series of virtual goods in said memory at said respective adjacent series of addresses,
c. storing said series of virtual goods in said memory at said adjacent series of addresses,
d. providing a display which is operatively connected to said memory for displaying said series of virtual goods stored in said memory at said adjacent series of addresses,
e. providing a mechanism which said operator can manipulate to assign ownership of virtual goods to other users of the system on said display in exchange for any other virtual goods
f. providing a memory controller which will:
a. Assign ownership of any virtual good which said operator manipulates via said input means to any other user of said system, and
b. Allowing the original user to accept in trade any virtual good that any other user assigns to them using said memory.
